(19) United States
(12) Patent Application Publication
(10) Pub. No.: US 2025/0371581 A1
(43) Pub. Date: Dec. 4, 2025

(54) INTELLIGENT PEER-TO-PEER TEXT DATA AUGMENTATION

(71) Applicant: REGLIDER - FZCO, Dubai (AE)

(72) Inventors: Dan Fishman, Netanya (IL); Maria Fishman, Netanya (IL)

(73) Assignee: REGLIDER - FZCO, Dubai (AE)

(21) Appl. No.: 19/038,012

(22) Filed: Jan. 27, 2025

Related U.S. Application Data
(60) Provisional application No. 63/654,451, filed on May 31, 2024.

(51) Int. Cl. G06Q 30/0251; G06F 9/451; G06F 40/134; G06F 40/279

(52) U.S. Cl. CPC G06Q 30/0269; G06F 9/451; G06F 40/134; G06F 40/279

(57) ABSTRACT

Disclosed herein are system, device, method and/or computer program product embodiments for intelligently augmenting conversation text data in a peer-to-peer messaging platform. An embodiment may first receive conversation text data from a peer-to-peer messaging platform. The embodiment may then identify a keyword within the conversation associated with a desired product or service. The embodiment may then query a data store for advertisements associated with the identified keyword. The embodiment may then select an advertisement using an advertisement auction service. Finally, the embodiment may transmit the identified keyword and advertisement to the peer-to-peer messaging platform, after which the peer-to-peer messaging platform may augment the conversation data with the identified keyword and advertisement.

### CROSS-REFERENCE TO RELATED APPLICATIONS

This application claims the benefit of U.S. Patent Application No. 63/654,451, filed on May 31, 2024, and to International Application No. PCT/IB2024/056820, filed on Jul. 12, 2024, the contents of which are incorporated herein by reference in their entirety.

### BACKGROUND

Peer-to-peer messaging platforms have become a popular means for modern communication, allowing individuals to connect over the internet. However, as popular as these platforms have become, they encounter the problem of data opacity. These systems oftentimes act like black-boxes and leave users unaware of how their conversation data is being processed behind the scenes. This lack of transparency raises concerns about data privacy and data security.

Furthermore, existing methods struggle to intelligently integrate relevant contextual information such as advertisements into conversations without compromising data security. Peer-to-peer messaging platforms do not have a reliable channel for delivering personalized and contextually relevant content to their users within their conversations. As a result, advertisers resort to opaque methods that may rely on sensitive conversation data to push advertisements on other platforms. These trends only increase data opacity surrounding the possibility of private conversations being analyzed and exploited for targeted advertising or other purposes without consent or awareness.

### BRIEF DESCRIPTION OF THE DRAWINGS

The accompanying drawings are incorporated herein and form a part of the specification.

FIG. 1 is a block diagram illustrating example for a text augmentation system (TAS), according to some embodiments.

FIG. 2 is a block diagram illustrating example for a marketplace, according to some embodiments.

FIG. 3A illustrates an example text augmentation, according to some embodiments.

FIG. 3B illustrates another example text augmentation, according to some embodiments.

FIG. 4 illustrates an example method of augmenting conversation text data, according to some embodiments.

FIG. 5 illustrates a flow diagram of an example method, according to some embodiments.

FIG. 6 illustrates a flow diagram of an example method, according to some embodiments.

FIG. 7 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method, and/or computer program product embodiments, and/or combinations and sub-combinations thereof, for augmenting conversation text data to reduce data opacity and improve data transparency of advertising methods within peer-to-peer messaging platforms.

In today's digital age, peer-to-peer messaging platforms allow individuals to communicate and share information seamlessly over the Internet, many of which promise data security and privacy to their users. However, these platforms usually operate in a black-box fashion, leaving users unsure whether their data is truly secure and whether their data is being processed behind the scenes.

A common phenomenon occurs where users may encounter advertisements on different platforms or websites for products or services they have discussed in supposedly private conversations. This phenomenon raises concerns about data privacy and potential misuse of sensitive data for targeted advertising purposes. And while the targeted advertisements might just be a result of unconscious user interactions with content the users are interested in, the lack of transparency surrounding the use of conversation data for advertising purposes still remains a pressing issue. Users should be allowed to know how their data is being managed within peer-to-peer messaging platforms. As such, a core technical issue lies in the data opacity of current methods for intelligently processing conversation text data in peer-to-peer messaging platforms for generating personalized contextual information, such as advertisements.

Various embodiments in accordance with the present disclosure overcome the aforementioned technological problems by intelligently augmenting conversation text data in a peer-to-peer messaging platform. A text augmentation system may first receive raw conversation text data from a peer-to-peer messaging platform. The text augmentation system may then leverage a natural language processing (NLP) service to identify any keywords in the raw conversation text data that may be associated with a desired product or service. For example, a text augmentation system may receive a message that reads: “Doing good as well. Planning a vacation. Can you recommend a good hotel in Dubai?” The NLP service may analyze the raw text data, identify the keywords “hotel in Dubai”, and determine that the user is interested in booking a hotel in Dubai. The text augmentation system may then query a data store using these keywords for any existing associated advertisements. If multiple advertisements are found, text augmentation system may then select one or more of the advertisements using an advertisement auction service. Upon selecting the one or more advertisements, the text augmentation system may then transmit the identified keyword and associated advertisement or advertisements to the peer-to-peer messaging platform to augment the conversation text data.

In some embodiments, the conversation text data may be augmented by embedding a hyperlink within the identified keywords. In some embodiments, the conversation text data may be augmented by adding a popup or dropdown next to the identified keywords. In some embodiments, the conversation text data may be by any means that may differentiate the keyword text from the rest of the message. For example, the keyword text may be highlighted. The keyword text may also be given a different font color from the other words in the message. The keyword text may also be given a shimmer or shining text effect. By doing so, users may see exactly which words in a message are being processed for generating relevant advertisements. This allows them to accurately trace the flow of data, thereby removing data opacity concerns surrounding how subsequent advertisements are generated, especially ones outside of the peer-to-peer messaging platform.

In addition to reducing data opacity and improving data transparency, this text augmentation system has numerous additional technological and practical benefits. First, by leveraging modern NLP services, the text augmentation system more accurately determines which keywords in a message are actually associated with a product or service that a user can benefit from. In some embodiments, the NLP service may extract additional contextual information from the message or previously sent messages to help determine which keywords should be identified. In a non-limiting example, a message might read: “I am so torn between buying a cat and buying a dog. Dad would be so upset if I got a dog though, so maybe I'll just get a cat.” Given this message, the NLP service may determine that the user wants both a “cat” and a “dog” but ultimately only identify “cat” as the keyword, since the user has expressed concerns about buying the dog. By leveraging modern NLP services, the text augmentation system is able to intelligently identify the keyword to be processed. As a result, users may be more inclined to accept and interact with these more personalized advertisements.

Second, augmenting the conversation text data is non-intrusive and does not worsen the user experience, whereas conventional advertising methods are often intrusive and common pain points for users. These may include, but are not limited to, display ads that appear as banner or static advertisements, pop-up ads that automatically open new windows or overlays, and auto-redirect ads, which automatically redirect users to different sites oftentimes for click fraud. By simply augmenting the conversation text data, the advertisement is not forced upon the user, and the user has full control to decide whether or not they want to explore the associated advertisement. In fact, users may end up being more inclined to accept and interact with these advertisements due to their non-intrusive and subtle nature.

Third, augmenting the text data within the conversations themselves streamlines the product or service searching process for users. In a non-limiting example, a user might already be planning on setting aside some time to look for a specific product or service online. By augmenting the conversation text data with an advertisement, the user may skip the searching process altogether and connect to a vendor directly. In some embodiments, the system may be expanded to incentivize users to leverage the vendors within the embedded advertisements over other options by providing certain discounts or features when accessing the vendors through the messaging platform's augmented conversation text data. In a non-limiting example, the messaging platform may augment the conversation text data with a special link that applies a discount code on the next transaction made on the vendor website. As such, augmenting the conversation text data provides the user with seamless and streamlined access to products and services they are interested in.

Fourth, augmenting the text data within a conversation may facilitate additional functionalities that may be useful for a user. In some embodiments, the augmented text data may be configured to provide contextual information within a conversation. For example, a message may read, “I wonder how high Mt. Everest is.” In response, the augmented text data may present the requested information. In some embodiments, the augmented text data may be configured to integrate third party services into the messaging application. For example, rather than or in addition to an advertisement, an augmented conversation text data may initiate an embedded taxi booking service within the messaging application. An integrated embedded application may save the user a trip to the advertiser's website to perform a desired task.

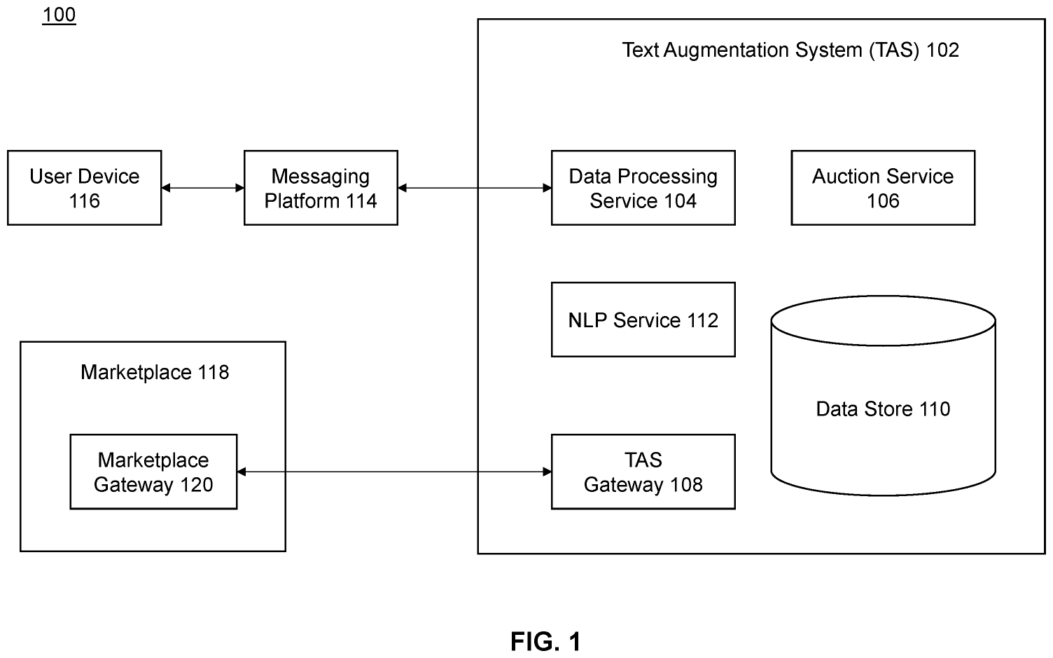

FIG. 1 is a block diagram of a system 100 illustrating example functionality for a text augmentation system (TAS) 102, according to some embodiments. The example system 100 is provided for the purpose of illustration only and does not limit the disclosed embodiments. TAS 102 may augment conversation text data to reduce data opacity and improve data transparency. Example system 100 may include TAS 102, user device 116, messaging platform 114, and marketplace 118. TAS 102 may include data processing service 104, auction service 106, natural language processing (NLP) service 112, TAS gateway 108, and data store 110. Marketplace 118 may include marketplace gateway 120.

In some embodiments, TAS 102 may be a software development kit (SDK) installed directly on messaging platform 114. In some embodiments, TAS 102 may operate as a cloud service that messaging platform 114 can subscribe to. TAS 102 may receive raw conversation text data from messaging platform 114, which is entered by user device 116. For example, TAS 102 may receive a message that reads: “Doing good as well. Planning a vacation. Can you recommend a good hotel in Dubai?” Upon receiving the raw conversation text data, TAS 102 may employ data processing service 104 to analyze and process the raw conversation text data. In some embodiments, data processing service 104 may analyze the raw conversation text data to identify a keyword or set of keywords that are associated with a desired product or service by a user. Messaging platform 114 may be any be any messaging application service, communication platform, or application with a chat functionality (i.e. a chatbot).

In some embodiments, data processing service 104 may employ NLP service 112 to identify the keyword or set of keywords. NLP service 112 may be a large language model or artificial intelligence proxy that connects with closed source enterprise application program interfaces (APIs). In some embodiments, NLP service 112 may be an open source model. These powerful models are able to analyze conversation text data and accurately identify where and when a user might benefit most from an advertisement. Any known or future large language models may be substituted without departing from the scope of the technology described herein.

A key difference between utilizing these powerful large language models over traditional NLP or rule-based methods is that large language models are able to understand and extract additional semantic information from conversation text data such as context and emotions. In a non-limiting example, NLP service 112 may receive a message that reads: “I really want to buy a new Mercedes, but I have only a few thousand dollars in my bank account. Instead, I will buy a used Toyota.” Traditional NLP or rule-based methods may identify that the user wants to either buy a Mercedes, a used Mercedes, a Toyota, or a used Toyota. However, NLP service 112 may extract the needed contextual information from the rest of the message, such as the user not having enough money to buy a new Mercedes. As a result, NLP service 112 may just identify the keyword “used Toyota” based on the conversation text data and the extracted context. This result may more accurately align with the user's actual intentions and needs.

Upon identifying the keyword or keywords, data processing service 104 may query data store 110 for one or more advertisements associated with the identified keyword. Each advertisement in data store 110 may be associated with a corresponding advertisement campaign. As used herein, an advertisement campaign may refer to an advertisement and any associated metadata including but not limited to advertisement budget, advertisement bidding values, advertisement location targeting, effective time windows, and advertisement statistics. In some embodiments, data store 110 may contain keyword-advertisement pairings configured by advertisers through marketplace 118.

In some embodiments, the query initiated by data processing service 104 may return an exact keyword match. For example, if data processing service 104 queries data store 110 with the keywords “cheap Lakers tickets”, the query may only return advertisements with the exact keywords “cheap Lakers tickets.” In some embodiments, the query initiated by data processing service 104 may return any similar or associated keyword-advertisement pairings. For example, a query using the same keywords from before may return advertisements with keywords such as “Lakers tickets”, “Lakers tickets on sale”, “best Lakers tickets”, “Lakers game”, and more. In some embodiments, data processing service may employ vector or string similarity algorithms to determine a similarity score between the queried keywords and the keywords inside data store 110. In some embodiments, TAS 102 may define a preconfigured threshold value to determine which keyword-advertisement pairings are returned, based on calculated similarity scores falling within the threshold value. In some embodiments, a threshold value may be configured by the advertisers, the messaging platform, or the user for additional customization and/or personalization.

In some embodiments data processing service 104 may employ auction service 106 to select an advertisement or advertisements from among the results returned by the query. In some embodiments, auction service 106 may include a proxy connected to a third-party API. When making a selection, auction service 106 may analyze values from the advertisements' corresponding advertisement campaigns. In a non-limiting example, auction service 106 may analyze advertisement bid, advertisement quality, advertisement location target, effective time windows when conducting the auction. In some embodiments, auction service 106 may calculate an auction score for each query result by weighting each metadata value and summing the weighted values together. Auction service 106 may select the advertisement with the highest auction score to be returned to data processing service 104.

In some embodiments, an auction score can be determined using a machine learning model. The machine learning model may be trained to accept advertisement campaign metadata values and make a score prediction. The machine learning model may be a classification or regression model, including but not limited to Naïve Bayes, Support Vector Machines, Decision Trees, Random Forest, Hidden Markov Models, Neural Networks, Gradient Boosting Machines, and Gaussian Mixture Models. In a non-limiting example, the training data may include labeled auction scores that reflect real world advertisement performance. For example, advertisements that led to successful user interaction and completed transactions may receive a high auction score. Similarly, advertisements that did not lead to a successful user interaction or completed transaction may receive a low auction score. In some embodiments, advertisements with the highest running total transaction amounts may receive a high auction score. Similarly, advertisements with low running total transaction amounts may receive a low auction score.

A machine learning model may better capture the relationships between the different advertisement campaign metadata values compared to a blind weighting strategy. This may be the case especially when the data is non-linear in nature. By training on real world data, the machine learning model may learn certain trends. In a non-limiting example, the machine learning model may learn that the campaigns with the highest bids do not always necessarily create the most successful advertisements. In another non-limiting example, the machine learning model may learn that campaigns with high advertisement quality but insufficient bid values may not survive the auction process and appear in front of users enough times to generate clicks and revenue.

In some embodiments, advertisement campaigns may be configured by advertisers in marketplace 118. Marketplace 118 may provide an accessible and interactive interface for advertisers to initiate and manage different advertisement campaigns. Marketplace 118 may be a mobile application or a web application. TAS 102 may communicate with marketplace 118 through secure API gateway communication channels TAS gateway 108 and marketplace gateway 120. TAS 102 may store the configured advertisement campaign metadata inside data store 110.

In some embodiments, advertisers may define their desired keywords and build corresponding advertisements to those keywords. In some embodiments, advertisers may define bidding values and strategies associated with each advertisement that may be analyzed by auction service 106 when conducting auctions. In some embodiments, advertisers may define a maximum bid or a minimum bid. Advertisers may also define a budget associated with each advertisement and a corresponding bidding strategy including but not limited to cost per click (CPC), cost per thousand impressions (CPM), and cost per acquisition (CPA). A CPC strategy may involve setting bids to maximize the number of times an advertisement may be clicked within a budget. A CPM strategy may involve setting bids to maximize the number of impressions or views an advertisement may receive within a budget. A CPA strategy may involve setting bids to maximize the number times a new customer may be acquired within a budget.

In some embodiments, marketplace 118 may display different statistics associated with an advertisement campaign. In a non-limiting example, marketplace 118 may display the running total of clicks, impressions, click-through rate (CTR), and billing fees for each advertisement campaign during its lifetime. CTR may refer to the rate at which an advertisement was clicked after being viewed. In some embodiments, auction service 106 may utilize the marketplace statistics when conducting auctions between various advertisement campaigns. In a non-limiting example, an advertisement with a higher CTR may receive a higher weighting when calculating a corresponding auction score. In another non-limiting example, the CTR may be included as a feature when training a machine learning model for predicting auction scores and making inferences with the machine learning model.

In some embodiments, TAS 102 may transmit the associated advertisement and keywords back to messaging platform 114 after receiving the results of the auction. Messaging platform 114 may then augment the conversation text data using the received advertisement or advertisements and associated keywords. In some embodiments, messaging platform 114 may embed the selected advertisement as a hyperlink within the identified keyword. The advertisement may include an advertisement title, advertisement image, and advertisement Uniform Resource Locator (URL). In some embodiments, a direct hyperlink to the advertisement URL may be embedded within the identified keyword. In some embodiments, the messaging platform 114 may embed the advertisement as a popup or dropdown element next to the identified keyword. In some embodiments, messaging platform 114 may augment the conversation text data by any means that may differentiate the keyword text from the rest of the message. In a non-limiting example, messaging platform 114 may highlight the background surrounding the keyword. Messaging platform 114 may also change the text color of the keyword. After augmenting the conversation text data, messaging platform 114 may display the augmented message to the user through user device 116. As a result of this message augmentation, the user may identify exactly which keyword is being associated with an advertisement.

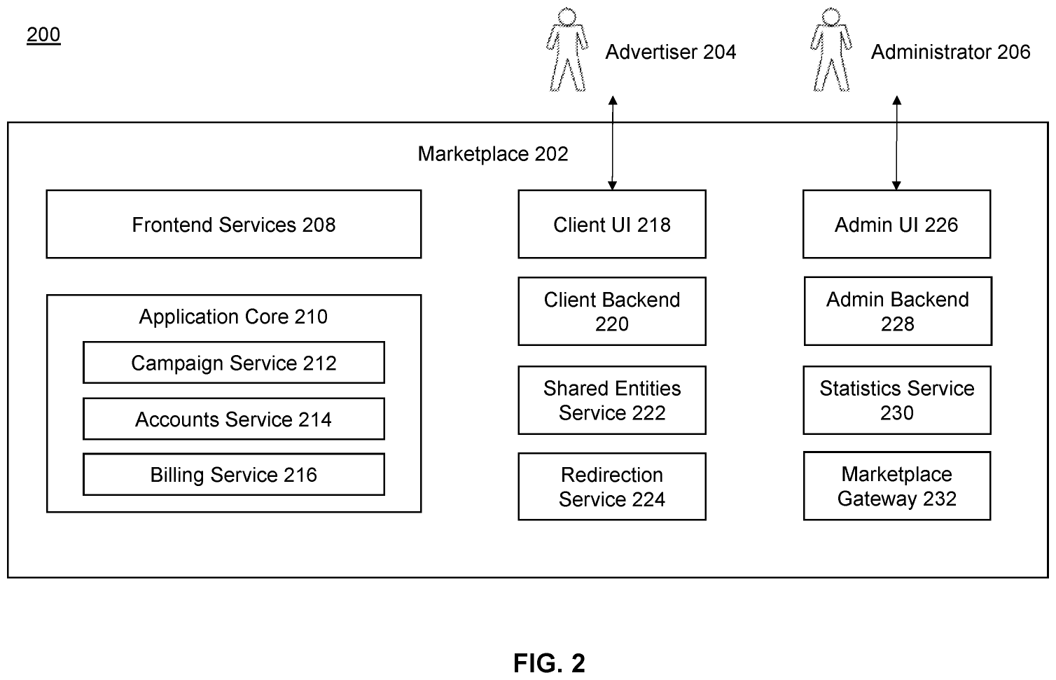

FIG. 2 is a block diagram 200 illustrating an example marketplace 202, according to some embodiments. Marketplace 202 may be an example of marketplace 118 (of FIG. 1) and may communicate with TAS 102 to facilitate the augmentation of conversation text data. The example marketplace 118 includes various components, however it is understood that in other embodiments, marketplace 118 may include components in addition to or different from those described below.

In some embodiments, advertiser 204 and administrator 206 may interact with marketplace 202. In some embodiments, marketplace 202 may include frontend services 208, application core 210, client user interface (UI) 218, client backend 220, shared entities service 222, redirection service 224, admin UI 226, admin backend 228, statistics service 230, and marketplace gateway 232. Marketplace gateway 232 may be an example of marketplace gateway 120 (of FIG. 1). Application core 210 may include campaign service 212, accounts service 214, and billing service 216.

In some embodiments, advertiser 204 may interact with marketplace 202 through client UI 218. Client UI may leverage frontend services 208 and client backend 220 to connect to application core 210. In some embodiments, advertiser 204 may wish to initiate and manage campaigns with marketplace 202. Advertiser 204 may first create an account to manage different campaigns on marketplace 202. Marketplace 202 may employ application core 210 to create an account using accounts service 214. Advertiser 204 may also set up billing information through marketplace 202. In some embodiments, application core 210 may employ billing service 216 to configure the billing information entered by advertiser 204. After advertiser 204 creates an account and configures billing information, advertiser 204 may begin building an advertisement campaign.

In some embodiments, advertiser 204 may enter an advertisement and associated keywords through client UI 218. In some embodiments, an advertisement may include an advertisement title, advertisement photo, and advertisement URL. In some embodiments, advertiser 204 may configure a keyword matching strategy and define how closely the conversation text data should match the keywords. In some embodiments, advertiser 204 may define a phrase matching strategy that will include the advertisement in any message containing the same meaning as the keywords. For example, phrase matching using the keyword “Lakers tickets” may identify “LA basketball game” or “Laker event Saturday.” In some embodiments, advertiser 204 may define a broad matching strategy that will include the advertisement in any message that relates to the keywords. For example, broad matching using the keyword “Lakers tickets” may identify “basketball tournament” or “AMC movie tickets.” In some embodiments, advertiser 204 may define an exact matching strategy that will include the advertisement only in messages that contain the same keywords and meaning inside the message. For example, exact matching using the keyword “Lakers tickets” may identify “Lakers game” or “Lakers match”.

In some embodiments, advertiser 204 may define bidding values and strategies associated with each advertisement. In some embodiments, advertiser 204 may define a maximum bid or a minimum bid. Advertiser 204 may also define a budget associated with each advertisement and a corresponding bidding strategy including but not limited to cost per click (CPC), cost per thousand impressions (CPM), and cost per action (CPA). A CPC strategy may involve setting bids to maximize the number of times an advertisement may be clicked within a budget. A CPM strategy may involve setting bids to maximize the number of impressions or views an advertisement may receive within a budget. A CPA strategy may involve setting bids to maximize the number times customer actions (e.g. sales, sign-ups, installs, etc.) may be performed within a budget.

In some embodiments, marketplace 202 may redirect users to an advertisement's URL using redirection service 224 when an advertisement is clicked on a user device. In some embodiments, marketplace 202 may employ shared entities service 222 to manage any dynamic variables shared across the marketplace services. In some embodiments, marketplace 202 may include a single sign-on (SSO) service that authenticates advertiser 204 and administrator 206 inside marketplace 202. In some embodiments, administrator 206 may monitor and manage marketplace 202 through admin UI 226 and admin backend 228. In some embodiments, marketplace 202 may display different statistics associated with an advertisement campaign using statistics service 230.

In a non-limiting example, statistics service may track the running total of clicks, impressions, click-through rate (CTR), and billing fees for each advertisement campaign during its lifetime. In some embodiments, statistics service 230 may also calculate different fee related statistics in addition to running totals of billing fees such as but not limited to average cost-per-click (CPC), cost-per-view (CPV), and cost-per-action (CPA). CPC may refer to the average amount an advertiser 204 is charged per clicked advertisement in the campaign. CPV may refer to the average amount an advertiser 204 is charged per impression or view of an advertisement in the campaign. CPA may refer to the amount an advertiser 204 is charged per successful customer action from the advertisement, such as but not limited to a product purchase, an installation, a sign-up, etc.

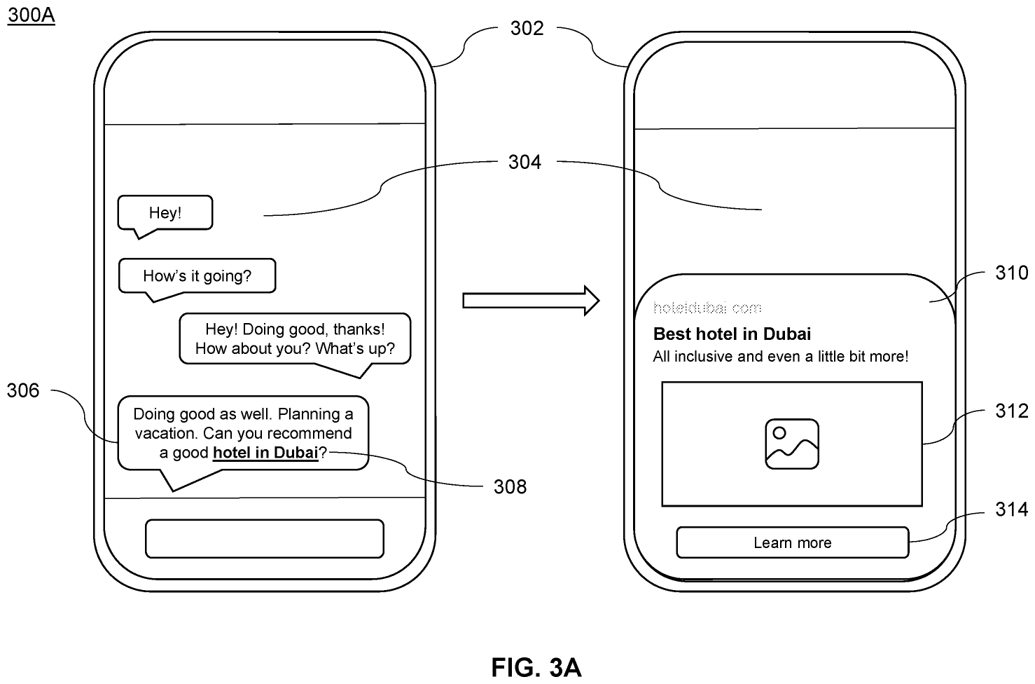

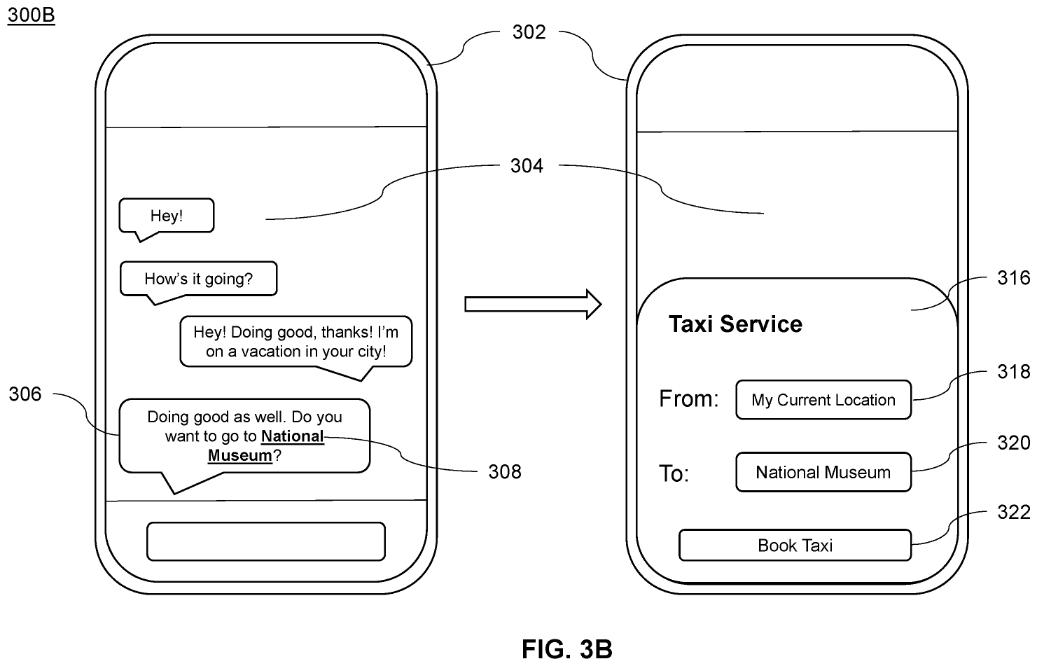

FIG. 3A illustrates an example text augmentation 300A, according to some embodiments. Text augmentation 300A shall be described with reference to TAS 102 (of FIG. 1). However, text augmentation 300A is not limited to that example system. The text augmentation provided in FIG. 3A is merely exemplary, and one skilled in the relevant art(s) will appreciate that many approaches may be taken to provide a suitable text augmentation 300A in accordance with this disclosure. In some embodiments, text augmentation 300A may include user device 302, messaging application 304, augmented message 306, hyperlinked keyword 308, advertisement 310, advertisement image 312, and advertisement link 314.

In some embodiments, messaging platform 114 may augment conversation text data in messaging application 304. For example, messaging platform 114 may augment a conversation message that reads: “Doing good as well. Planning a vacation. Can you recommend a good hotel in Dubai?” Messaging platform 114 may then transmit the contents of the conversation message to TAS 102. TAS 102 may then analyze the contents of the conversation message to identify a keyword associated with a desired product or service. For example, TAS 102 may determine that a user wants to book a hotel in Dubai and identify the keyword “hotel in Dubai.” In some embodiments, TAS 102 may identify multiple keywords inside the conversation message. For example, TAS 102 may have also identified “vacation” as a keyword. TAS 102 may then query a data store for one or more associated advertisements with keyword 308.

In some embodiments, TAS 102 may receive multiple advertisements associated with the keyword as a result of the query. Then, TAS 102 may select an advertisement or advertisements among the results using auction service 106. In some embodiments, auction service 106 may generate auction scores for each result and return the result with the highest auction score. In some embodiments, auction service 106 may return multiple results. For example, auction service 106 may return the advertisements with the three highest auction scores. In some embodiments, auction service 106 may return all of the advertisements with auction scores above a preconfigured threshold value. The auction score of an advertisement may be related to expected financial success, which may be measured by advertisement statistics such as CTR and advertisement clicks. For example, a higher CTR may imply higher user engagement, which may lead to a higher auction score. In another example, more advertisement clicks or impressions may also imply user engagement, which may also lead to a higher auction score.

In some embodiments, TAS 102 may transmit the result of auction service 106 back to messaging platform 114. Messaging platform 114 may then augment the conversation data to produce augmented message 306. In some embodiments, messaging platform 114 may produce augmented message 306 by embedding the returned advertisement as a hyperlink within the keyword and create hyperlinked keyword 308. In some embodiments, messaging platform 114 may produce augmented message 306 by embedding the returned advertisement as a popup or dropdown next to the keyword.

In some embodiments, a user may wish to view the contents of augmented message 306 by interacting with hyperlinked keyword 308. For example, a user may click on an underlined “hotel in Dubai” inside an augmented message that reads “Doing good as well. Planning a vacation. Can you recommend a good hotel in Dubai?” In some embodiments, advertisement 310 may be displayed on user device 302. Advertisement 310 may show advertisement details such as but not limited to advertisement title, advertisement description, advertisement URL, advertisement image 312, advertisement video, advertisement audio or other media content, and advertisement link 314. Advertisement 310 may also display an address, a telephone number, a mode of operation, prices, an application form, promotions, and additional links. In some embodiments, a user may wish to interact with advertisement 310 to view the advertised product or service. For example, a user may click advertisement link 314. In some embodiments, advertisement link 314 may redirect a user to an advertisement URL or website. In some embodiments, advertisement link 314 may initiate an additional application associated with the advertisement embedded within the messaging application chat. For example, a user may click an advertisement link 314 associated with a taxi service and be presented with an embedded application to book a taxi ride within the messaging application. In some embodiments, messaging application 304 may display multiple advertisements returned by the auction. In a non-limiting example, a user may be able to swipe or click between the different advertisements displayed in messaging application 304. As a result, the user may have multiple reference points to compare an initial advertisement 310. In some embodiments, the advertisement link 314 may be a special discount link that provides a user with a discount when purchasing a product or service. This may serve to incentivize users to participate in the augmented messaging environment and interact with the advertisements.

FIG. 3B illustrates another example text augmentation 300B, according to some embodiments. This example includes similar components as FIG. 3A, namely user device 302, messaging application 304, augmented message 306, and hyperlinked keyword 308. However, instead of advertisement 310, text augmentation 300B includes embedded taxi service application 316, pick-up location 318, drop-off location 320, and book taxi button 322. In some embodiments, text augmentation 300B may be displayed as a direct result from a user interaction with augmented conversation text data, such as a user clicking a hyperlinked keyword. In some embodiments, text augmentation 300B may be displayed after a user clicks an advertisement link, such as advertisement link 314 (of FIG. 3A). In some embodiments, embedded application 316 may be connected to a third-party service. For example, a user may connect to a taxi service through embedded application 316 by entering a pick-up location 318 and drop-off location 320 and clicking book taxi button 322. As a result, the embedded application may find and book a relevant taxi for the user automatically.

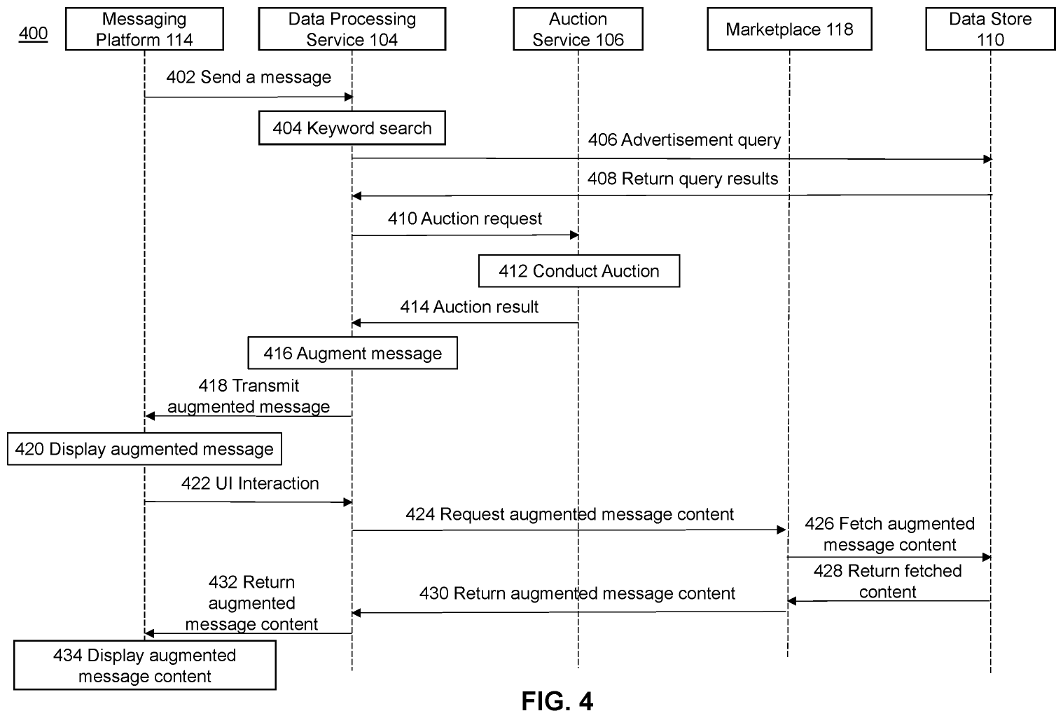

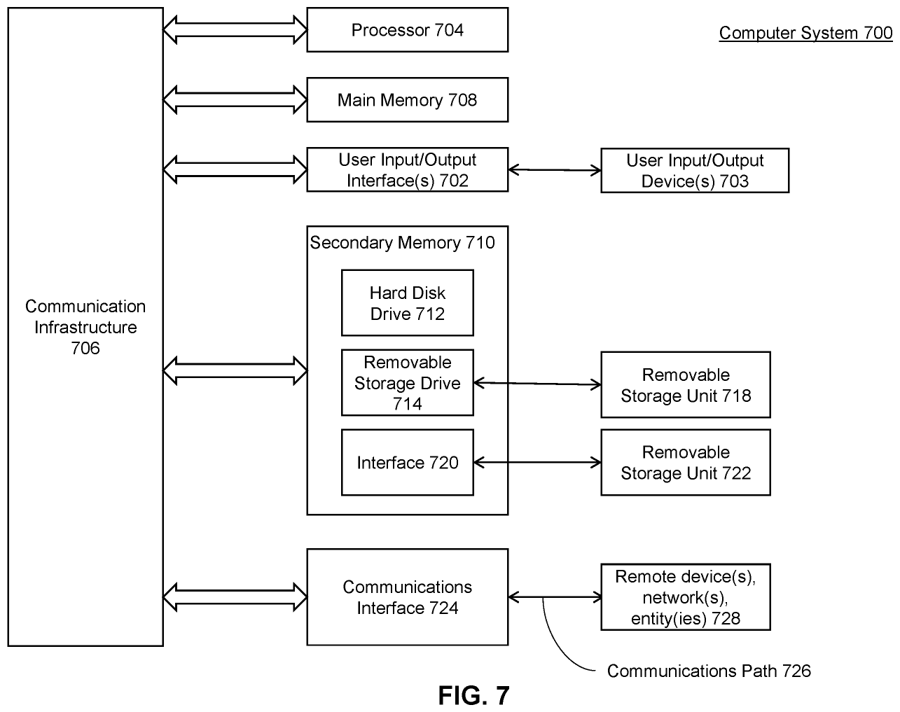

FIG. 4 illustrates an example method 400 of augmenting conversation text data, according to some embodiments of the disclosure. As a convenience and not a limitation, FIG. 4 may be described with regard to elements of FIGS. 1, 2, and 3. The example method 400 may represent the operation of devices (e.g. messaging platform 102, data processing service 104, auction service 106, marketplace gateway 108, data store 110, or a combination thereof of FIG. 1) implementing augmenting conversation text data. The example method 400 may also be performed by computer system 700 of FIG. 7. But the example method 400 is not limited to the specific embodiments depicted in those figures and other systems may be used to perform the method, as will be understood by those skilled in the art. It is to be appreciated that not all operations may be needed, and the operations may not be performed in the same order as shown in FIG. 4.

At 402, messaging platform 114 may transmit a message to be augmented to data processing service 104 of TAS 102. In some embodiments, messaging platform 114 may also send previous messages in the conversation history or the entire conversation history to data processing service 104 along with the message to be augmented. For example, messaging platform 114 may want to provide context for the message to be augmented.

At 404, data processing service 104 may perform a keyword search to identify a keyword from the message to be augmented that is associated with a desired product or service by a user. In some embodiments, data processing service 104 may employ NLP service 112 to intelligently extract the keyword from the message. In some embodiments, data processing service 104 may also include the previous messages or entire conversation history associated with the message to be augmented when invoking NLP service 112 to provide additional context and produce a more accurate result. For example, data processing service 104 may receive an ambiguous message that reads, “Bucks would be a good choice.” If data processing service 104 only receives this message and no other context, NLP service 112 may not know what the message is about. For example, “Bucks” could have multiple meanings, many of which are not common items people would look to purchase (e.g. the basketball team, male deer, money, etc.). Therefore, to be statistically safe, NLP service 112 may not identify a keyword. However, data processing service 104 may receive previous conversation history that reveals that the user is looking to buy some shoes for an upcoming backpacking trip. As a result of this added context, NLP service 112 may understand that “Bucks” in the message refers to a type of shoe and thus may return the keyword “Bucks”. Having additional context will help the NLP service 112 return accurate keywords that actually reflect the intentions of the user.

At 406, data processing service 104 may query data store 110 with the results of the keyword search for associated advertisements and campaign metadata. In some embodiments, the query may employ vector or string similarity algorithms to determine a similarity score between the queried keywords and the keywords inside data store 110. In some embodiments, advertisement campaigns may define a keyword matching strategy for the query to consider. For example, an advertisement campaign may define a phrase matching strategy which may return the keyword in queries for items containing the same meaning. In another example, an advertisement campaign may define a broad matching strategy which may return the keyword in queries for related items. In another example, an advertisement campaign may define an exact matching strategy, which may return a keyword in queries for items with the same meaning.

At 408, data store 110 may return the query results to data processing service 104. In some embodiments, data store 110 may return keyword-advertisement pairings as a result of the query. In some embodiments, campaign metadata may include advertisement budget, advertising bidding values, advertisement location targeting, effective time windows, and advertisement statistics.

At 410, data processing service 104 may send an auction request to auction service 106 to trim the results of the keyword search. The auction request may include the keywords returned by the query and the campaign metadata. In some embodiments, data processing service 104 may employ a local system to execute the auction request. In some embodiments, data processing service 104 may invoke a third party API to perform the auction.

At 412, auction service 106 may conduct an auction to select and return an advertisement from the auction request. In some embodiments, auction service 106 may calculate an auction score for each query result by weighting each associated campaign metadata value and summing the weighted values together. In some embodiments, the auction score may be determined by a machine learning model trained to accept campaign metadata values and make a score prediction. The machine learning model may be trained on real world advertisement performance, where successful advertisements may be given higher auction scores, and less successful advertisements may be given lower auction scores. In some embodiments, the auction scores may be influenced by advertisement statistics. For example, an advertisement with a higher CTR may be given a higher auction score. In another example, a newly created advertisement with few clicks and impressions may be given a lower score.

At 414, auction service 106 may return the results of the auction to data processing service 104. In some embodiments, auction service 106 may return multiple auction results. In a non-limiting example, auction service may be configured with a threshold auction score value, where any advertisements with scores above the threshold may be returned.

At 416, data processing service 104 may augment the message with the results of the auction. In some embodiments, data processing service 104 may embed an advertisement inside an associated keyword of conversation text data. In some embodiments, data processing service 104 may embed an advertisement inside a popup or dropdown next to the associated keyword of conversation text data. Alternatively, data processing service 104 may choose not to augment the message.

At 418, data processing service 104 may transmit the augmented message to messaging platform 114. Alternatively, data processing service 104 may transmit the raw keyword-advertisement pairings returned by the auction to the messaging platform. In this case, the messaging platform may augment the conversation text data accordingly.

At 420, messaging platform 114 may display the augmented message to the user. In some embodiments, messaging platform 114 may re-render conversation text data to show the augmented message. For example, the conversation text data may be re-rendered to underline the keyword associated with the advertisement. This way, the user may clearly see which word(s) and message(s) are associated with the advertisement.

At 422, messaging platform 114 may notify data processing service 104 that a UI interaction has occurred. In some embodiments, a UI interaction may include the user clicking on the hyperlinked keyword inside the conversation text data. In some embodiments, a UI interaction may include the user clicking on a popup or dropdown button next to the keyword inside the conversation text data.

At 424, data processing service 104 may request the augmented message content from marketplace 118. For example, data processing service 104 may send a request to obtain the advertisement title, advertisement URL, and advertisement image associated with the returned keyword.

At 426, marketplace 118 may process the request for the augmented message and fetch the augmented message content from data store 110 using a query. For example, marketplace 118 may use a message identifier and keyword to obtain the associated advertisement title, advertisement URL, and advertisement image. In some embodiments, data store 110 may include a cache of frequently requested augmented message content to improve efficiency.

At 428, data store 110 may return the fetched augmented message content to marketplace 118.

At 430, marketplace 118 may forward the fetched augmented message content to data processing service 104.

At 432, data processing service 104 may return the augmented message content to messaging platform 114.

At 434, messaging platform 114 may display the augmented message content on the messaging application. For example, the augmented message content may include a popup window or tab that displays the advertisement title, advertisement URL, advertisement image, and advertisement link. If the user is interested in the advertised content, the user may interact with the augmented message content by clicking the advertisement link. Messaging platform 114 may then redirect the user to the vendor website associated with the advertisement. In some embodiments, the augmented message content may include a special discount link that may apply a discount on any transactions initiated from the link. This may motivate a user to enroll in an intelligent augmented messaging environment for personalized and relevant advertisements. In some embodiments, the advertisement link may initiate an additional application associated with the advertisement embedded within the messaging application chat. For example, a user may click an advertisement link associated with a taxi service and be presented with an embedded application to book a taxi ride within the messaging application.

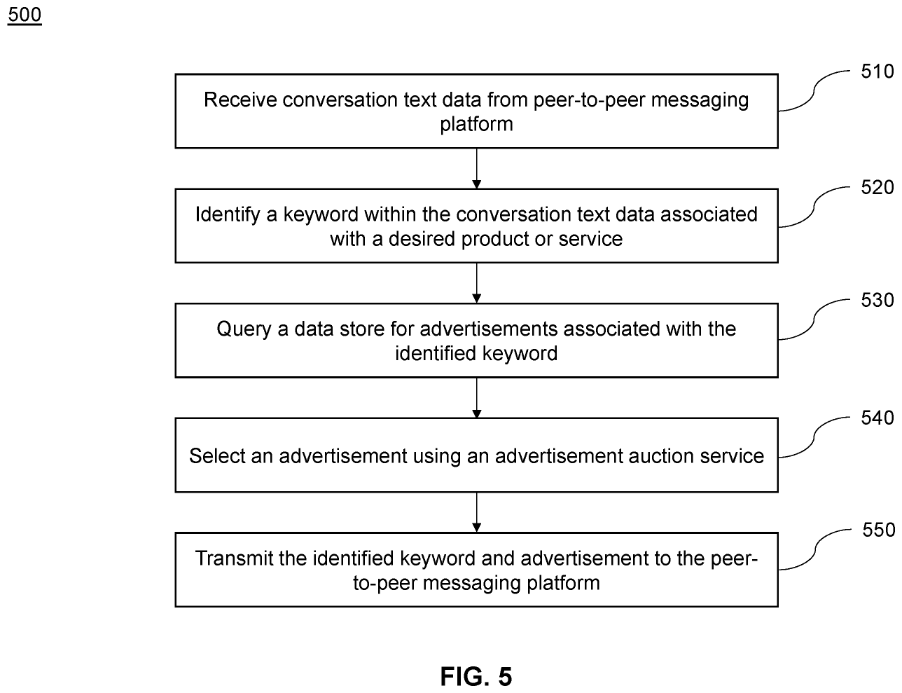

FIG. 5 is a flowchart 500 illustrating example operations for augmenting conversation text data, according to some embodiments. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art.

Method 500 shall be described with reference to FIG. 1. However, method 500 is not limited to that example embodiment.

In 510, a text augmentation system may receive text data from a peer-to-peer messaging platform. For example, TAS 102 may receive a message to be augmented from messaging platform 114. In some embodiments, TAS 102 may receive previous messages and conversation history associated with the message to be augmented.

In 520, a text augmentation system may identify a keyword within the conversation text data associated with a desired product or service. For example, TAS 102 may employ NLP service 112 to identify a keyword or keywords in the received message. NLP service 112 may be a large language model or artificial intelligence proxy that connects with closed source enterprise APIs. NLP service 112 may also be an open source model. These powerful models are able to analyze conversation text data and accurately identify where and when a user may benefit most from an advertisement.

In 530, a text augmentation system may query a data store for advertisements associated with the identified keyword. For example, TAS 102 may query data store 110 for advertisements associated with the keywords identified by NLP service 112. In some embodiments, each advertisement in data store 110 may be associated with corresponding campaign metadata. In some embodiments, data processing service 104 may employ vector or string similarity algorithms to determine a similarity score between the identified keywords and the keywords inside data store 110. In some embodiments, advertisement campaigns may define a keyword matching strategy for the query to consider. For example, the query may perform phrase matching, broad matching, or exact matching depending on the matching strategy defined by an advertisement campaign. In some embodiments, TAS 102 may preconfigure a similarity threshold and return keywords with similarity scores above the similarity threshold. In some embodiments, a similarity threshold may be configured by the messaging platform, advertisers, or users.

In 540, a text augmentation system may select an advertisement or advertisements using an advertisement auction service. For example, TAS 102 may employ auction service 106 to make a selection among the results of the query. In some embodiments, auction service 106 may calculate an auction score for each returned query result. In some embodiments, auction service 106 may weight different associated campaign metadata values and sum the weighted values together. In some embodiments, the auction score may be determined by a machine learning model trained to accept campaign metadata values and make a score prediction. In some embodiments, the auction scores may be influenced by advertisement statistics. Auction service 106 may then return the advertisement with the highest calculated auction score. In some embodiments, auction service 106 may return multiple advertisements. For example, auction service 106 may return advertisements with auction scores above a preconfigured threshold.

In 550, a text augmentation system may transmit the identified keyword and advertisement to the peer-to-peer messaging platform. For example, TAS 102 may transmit the keyword and advertisement from the auction results to messaging platform 114. In some embodiments, messaging platform 114 may augment the original conversation text data using the returned keyword and advertisement from the auction results. In some embodiments, messaging platform 114 may embed the advertisement as a hyperlink inside the keyword of the message. In some embodiments, messaging platform 114 may embed the advertisement as a popup or dropdown next to the keyword of the message. Messaging platform 114 may then display the augmented message to the user.

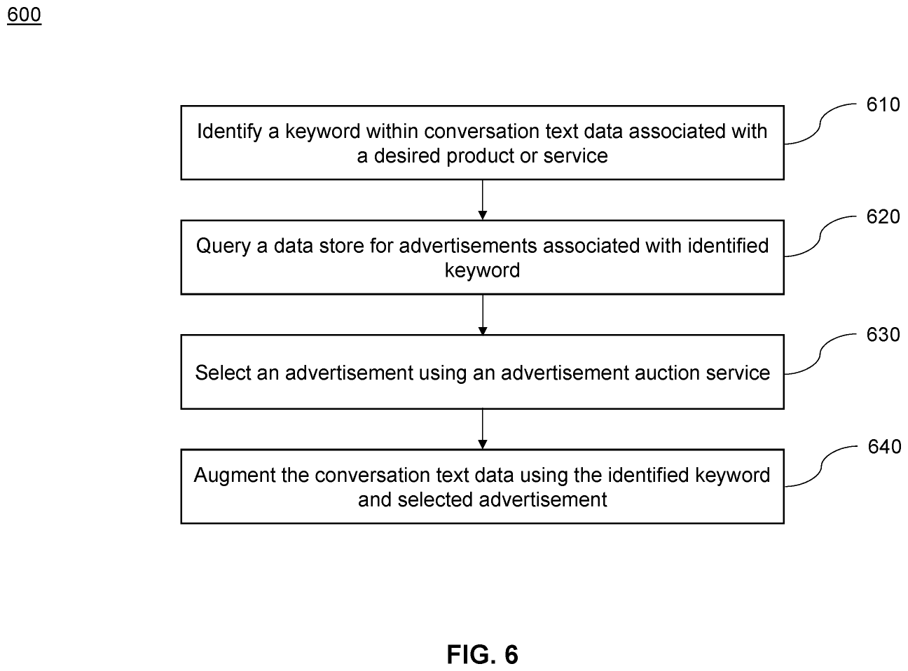

FIG. 6 is a flowchart 600 illustrating example alternate operations for augmenting conversation text data, according to some embodiments. 610, 620, and 630 are largely similar to 520, 530, and 540 of FIG. 5 respectively. To avoid redundancy, detailed explanations of these steps will be omitted for brevity. Similar to FIG. 5, FIG. 6 shall be described with reference to FIG. 1. However, method 600 is not limited to that example embodiment.

At 640, a text augmentation system may augment conversation text data using the identified keyword and selected advertisement. For example, TAS 102 may augment conversation data in messaging platform directly using the keyword and advertisement returned by auction service 106. In some embodiments, TAS 102 may embed the advertisement as a hyperlink inside the keyword of the message. In some embodiments, TAS 102 may embed the advertisement as a popup or dropdown next to the keyword of the message. TAS 102 may then display the augmented message to the user.

### Example Computer System

FIG. 7 depicts an example computer system useful for implementing various embodiments.

Various embodiments may be implemented, for example, using one or more well-known computer systems, such as computer system 700 shown in FIG. 7. One or more computer systems 700 may be used, for example, to implement any of the embodiments discussed herein, as well as combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 708, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for augmenting conversation text data in a peer-to-peer messaging platform, comprising:
receiving conversation text data from a peer-to-peer messaging platform;
identifying a keyword within the conversation text data associated with a desired product or service using a natural language processing (NLP) service;
querying a data store for one or more advertisements associated with the identified keyword;
selecting an advertisement from the one or more advertisements using an advertisement auction service;
transmitting the identified keyword and selected advertisement to the peer-to-peer messaging platform, wherein the peer-to-peer messaging platform in response to the transmitting augments the conversation text data using the identified keyword and the selected advertisement.

2. The computer-implemented method of claim 1, wherein the augmenting the conversation text data comprises:
embedding the selected advertisement as a hyperlink within the identified keyword.

3. The computer-implemented method of claim 1, wherein the augmenting the conversation text data comprises:
embedding the selected advertisement inside a popup or dropdown element next to the identified keyword.

4. The computer-implemented method of claim 1, wherein identifying the keyword comprises:
extracting a context from the conversation text data using the NLP service; and
identifying the keyword by analyzing the conversation text data and the context using the NLP service.

5. The computer-implemented method of claim 4, wherein extracting the context comprises:
analyzing conversation text data from previously sent messages in the peer-to-peer messaging platform using the NLP service.

6. A system, comprising:
one or more memories;
at least one processor each coupled to at least one of the memories and configured to perform operations comprising:
receiving conversation text data from a peer-to-peer messaging platform;
identifying a keyword within the conversation text data associated with a desired product or service using a natural language processing (NLP) service;
querying a data store for one or more advertisements associated with the identified keyword;
selecting an advertisement from the one or more advertisements using an advertisement auction service;
transmitting the identified keyword and selected advertisement to the peer-to-peer messaging platform, wherein the peer-to-peer messaging platform in response to the transmitting augments the conversation text data using the identified keyword and the selected advertisement.

7. The system of claim 6, wherein the augmenting the conversation text data comprises:
embedding the selected advertisement as a hyperlink within the identified keyword.

8. The system of claim 6, wherein the augmenting the conversation text data comprises:
embedding the selected advertisement inside a popup or dropdown element next to the identified keyword.

9. The system of claim 6, wherein identifying the keyword comprises:
extracting a context from the conversation text data using NLP service; and
identifying the keyword by analyzing the conversation text data and the context using the NLP service.

10. The system of claim 9, wherein extracting the context comprises:
analyzing conversation text data from previously sent messages in the peer-to-peer messaging platform using the NLP service.

11. A non-transitory computer-readable medium having instructions stored thereon that, when executed by at least one computing device, causes the at least one computing device to perform operations comprising:
receiving conversation text data from a peer-to-peer messaging platform;
identifying a keyword within the conversation text data associated with a desired product or service using a natural language processing (NLP) service;
querying a data store for one or more advertisements associated with the identified keyword;
selecting an advertisement from the one or more advertisements using an advertisement auction service;
transmitting the identified keyword and selected advertisement to the peer-to-peer messaging platform, wherein the peer-to-peer messaging platform in response to the transmitting augments the conversation text data using the identified keyword and the selected advertisement.

12. The non-transitory computer-readable medium of claim 11, wherein the augmenting the conversation text data comprises:
embedding the selected advertisement as a hyperlink within the identified keyword.

13. The non-transitory computer-readable medium of claim 11, wherein the augmenting the conversation text data comprises:
embedding the selected advertisement inside a popup or dropdown element next to the identified keyword.

14. The non-transitory computer-readable medium of claim 11, wherein identifying the keyword comprises:
extracting a context from the conversation text data using the NLP service; and
identifying the keyword by analyzing the conversation text data and the context using the NLP service.

15. The non-transitory computer-readable medium of claim 14, wherein extracting the context comprises:
analyzing conversation text data from previously sent messages in the peer-to-peer messaging platform using the NLP service.

16. A computer-implemented method for augmenting conversation text data in a peer-to-peer messaging platform, comprising:
identifying a keyword within conversation text data associated with a desired product or service using a natural language processing (NLP) service;
querying a data store for one or more advertisements associated with the identified keyword;
selecting an advertisement from the one or more advertisements using an advertisement auction service;
augmenting the conversation text data using the identified keyword and the selected advertisement.

17. The computer-implemented method of claim 16, wherein the augmenting the conversation text data comprises:
embedding the selected advertisement as a hyperlink within the identified keyword.

18. The computer-implemented method of claim 16, wherein the augmenting the conversation text data comprises:
embedding the selected advertisement inside a popup or dropdown element next to the identified keyword.

19. The computer-implemented method of claim 16, wherein identifying the keyword comprises:
extracting a context from the conversation text data using the NLP service; and
identifying the keyword by analyzing the conversation text data and the context using the NLP service.

20. The computer-implemented method of claim 19, wherein extracting the context comprises:
analyzing conversation text data from previously sent messages in the peer-to-peer messaging platform using the NLP service.
